(19) United States
(12) Patent Application Publication
(10) Pub. No.: US 2017/0061136 A1
(43) Pub. Date: Mar. 2, 2017

(54) APPLICATION PERMISSION RECOMMENDATION AND CONTROL

(71) Applicants: Virginia Commonwealth University Intellectual Property Foundation, Richmond, VA (US); The Regents of the University of Colorado, Denver, CO (US)

(72) Inventors: Carol Fung, Mechanicsville, VA (US); Bahman Rashidi, Richmond, VA (US); Tam Vu, Denver, CO (US)

(21) Appl. No.: 15/253,523

(22) Filed: Aug. 31, 2016

Related U.S. Application Data
(60) Provisional application No. 62/212,847, filed on Sep. 1, 2015.

(51) Int. Cl. G06F 21/57; G06F 21/62

(52) U.S. Cl. CPC G06F 21/577; G06F 21/6218

(57) ABSTRACT

In one example implementation, a method includes receiving, at a computing device, a request to grant a set of requested permissions to an application installed on the computing device, and sending, from the computing device, a permission query request to a recommendation server, where the permission query request includes an identifier for the application, and the set of requested permissions. The method may also include receiving, at the computing device, from the recommendation server, a set of permission recommendations, where the set of permission recommendations indicates whether the recommendation server recommends granting each requested permission from the set of requested permissions. The method may also include displaying the set of requested permissions and the set of permission recommendations, determining a set of granted permissions for the application, granted by a user of the computing device, from the set of requested permissions, and setting the permissions for the application on the computing device using the set of granted permissions.

### CROSS-REFERENCE TO RELATED APPLICATION

The present application is a non-provisional of and claims priority to U.S. Provisional Application No. 62/212,847, entitled “A Smartphone Permission Control Security Framework Based on Crowdsourcing,” filed Sep. 1, 2015, which is hereby incorporated by reference in its entirety as if fully set forth below.

### BACKGROUND

With the exponential growth of mobile device applications (also referred to herein as “apps”), it may not be realistic for application market places (sometimes referred to as “app stores”) to thoroughly verify if an app is legitimate or malicious. As a result, mobile device users can be left to decide for themselves whether an app is safe to use. Additionally, many apps available in markets collect data irrelevant to the main functions of the apps, which could cause leaking of private information or inefficient use of mobile resources.

In many current mobile device architectures, users can decide what resources are given to an application at installation. Between applications, the mobile operating system may prevent malicious apps from unauthorized access to other apps' resources by isolating resources controlled by each app. In the current setting, often users have to grant all resource access requests before installing and using an app. This permission control mechanism, however, has been proven ineffective to protect users' privacy and resources from malicious apps. Many smart phone apps also request to collect data irrelevant to the main function of the app. When installing a new app, it is not common for users to pay attention to the resource being requested, as many users tend to rush through prompted permission request screens to get to use the application. A small portion of users typically pay attention and make correct answers to permission granting questions. In addition, many current mobile operating system permission warnings do not help most users make correct security decisions.

It is with respect to these and other considerations that the various example implementations described herein are presented.

### BRIEF SUMMARY

In one aspect, the disclosed technology relates to a system which, in one example implementation, provides a recommendation system for apps that collects apps' permission requests and users' permission responses for the apps, from which a ranking system can be used to evaluate the expertise level of users and a voting system can be used to compute an appropriate response to the permission request (accept or reject). The system can be a participatory system that leverages permission responses from experts and peer users to suggest other users on how to respond to permission requests.

In another aspect, the disclosed technology relates to a method for managing application permissions which, in one example implementation, includes receiving, at a computing device, a request to grant a set of requested permissions to an application installed on the computing device. The application may be installed on the computing device in a probation mode or a trusted mode. The method may also include sending, from the computing device, a permission query request to a recommendation server, where the permission query request includes an identifier for the application, and the set of requested permissions. The computing device may be a mobile device and the application may be a mobile device application.

The method may also include receiving, at the computing device, from the recommendation server, a set of permission recommendations, where the set of permission recommendations indicates whether the recommendation server recommends granting each requested permission from the set of requested permissions. The set of permission recommendations may include recommendations on whether granting one or more of the requested permissions poses a risk to the security or privacy of the computing device and/or the user.

The method may also include displaying the set of requested permissions and the set of permission recommendations, and determining a set of granted permissions for the application, granted by a user of the computing device, from the set of requested permissions. The set of granted permissions may be granted by the user based at least in part on the set of permission recommendations. The method may also include setting the permissions for the application on the computing device using the set of granted permissions, and may further include sending, from the computing device to the recommendation server, the set of granted permissions.

The set of permission recommendations may be based on granted permissions from other users of the application on other respective computing devices or another application on other respective computing devices that is configured to perform at least some of the same functions of the application. Some or all of the other users may be determined to be expert users. Determining whether a user is an expert user may include determining the correctness of granted permissions by the user, based on historical data. One or more steps of the method as described above may be performed during run-time of the application on the computing device.

In yet another aspect, the disclosed technology relates to a computing device which, in one example implementation, includes a memory operatively coupled to a processor and configured for storing data and instructions that may be executed by the processor to cause the computing device to perform a method for managing application permissions. In yet another aspect, the disclosed technology relates to a computer readable medium storing instructions that, when executed by at least one processor, cause a computing device to a perform method for managing application permissions.

Other implementations, features, and aspects of the disclosed technology are described in detail herein and are considered a part of the claimed disclosed technology. Other implementations, features, and aspects can be understood with reference to the following detailed description, accompanying drawings, and claims.

### BRIEF DESCRIPTION OF THE FIGURES

Reference will now be made to the accompanying figures and flow diagrams, which are not necessarily drawn to scale, and wherein:

FIG. 1 is a schematic diagram of the architecture of a recommendation system 100 relating to application permissions, in accordance with an example implementation of the disclosed technology.

FIG. 2 is a flow diagram 200 showing permission checking and granting flow according to an example implementation of the disclosed technology.

FIG. 3 is a flowchart 300 showing a method of managing mobile device application permissions according to an example implementation of the disclosed technology.

FIG. 4 illustrates displayed content on a computing device, relating to granting permissions to an application, according to an example implementation of the disclosed technology.

FIG. 5 shows an illustrative block diagram of computing device system architecture 500 capable of performing one or more aspects of the disclosed technology in accordance with example implementations.

### DETAILED DESCRIPTION

In some aspects, the disclosed technology relates to mobile device operating systems and mobile device apps, and analyzing installation and run-time permission requests for mobile device apps. In some example implementations, systems, methods, and apparatuses can provide improved security on mobile devices with respect to new mobile apps. A recommendation may be presented by a system which encourages either accepting or rejecting the permission requests required by a new app in order for installation or functions at run-time to proceed. The recommendation may be based on crowdsourced data including historical data of apps' permission requests and users' permission responses. A ranking system may stratify the users, from which data is collected, identifying “experts” whose permission responses may be weighted more heavily. The underlying decision process may include game theoretical modeling.

Although example implementations (which may also be referred to herein as “example embodiments” or “exemplary embodiments” of the disclosed technology are explained in detail herein, it is to be understood that other embodiments are contemplated. Accordingly, it is not intended that the disclosed technology be limited in its scope to the details of construction and arrangement of components set forth in the following description or illustrated in the drawings. The disclosed technology is capable of other embodiments and of being practiced or carried out in various ways.

It must also be noted that, as used in the specification and the appended claims, the singular forms “a,” “an” and “the” include plural referents unless the context clearly dictates otherwise. By “comprising” or “containing” or “including” is meant that at least the named compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

A mobile device application recommendation system in accordance with some example implementations of the disclosed technology can help guide users to decide on which permissions should be granted to an app by providing low-risk recommendations from expert users. The system may also use an optional probation mode, in which permission requests are adaptively prompted to users which potentially improves the usability of the permission-granting mechanisms. The system may also allow app market places to rank their app based on their security and privacy ratings that are implicitly submitted by users.

In some example implementations, the framework of the system can allow users to use apps without granting all permissions. The system can allow the users to install untrusted apps under a “probation” mode, while the trusted apps are installed in normal “trusted” mode. In probation mode, users make real-time resource granting decisions when apps are running. The system can also allow for expert user opinions to be considered when permission requests appear. The system can also facilitate a user-help-user environment, where expert users are identified and their decisions are recommended to inexperienced users.

A key challenge is to expand the expert user base so that their expertise can cover all applications on the market. These expert users can be selected so that their responses and recommendations to peers are of high quality. In some example implementations, the system can start from a small set of trusted expert users and propagate the expert evaluation using various learning models

In some example implementations, a mobile device application recommendation system may collect users' permission-request responses, analyze the responses to eliminate untruthful and biased responses, suggest to other users with low-risk responses to permission requests, and rank apps based on their security and privacy risk level inferred from users' responses.

### System

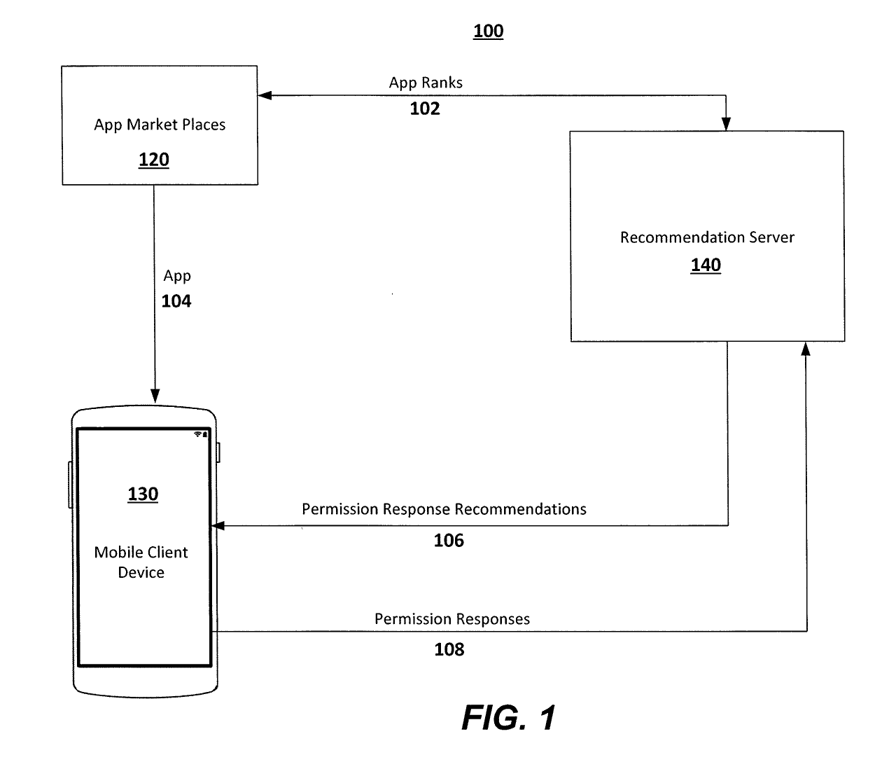

FIG. 1 shows a schematic diagram of the architecture of a recommendation system 100 in accordance with an example implementation of the disclosed technology. The recommendation system may be composed of a thin OS patch allowing mobile clients to automatically report users' responses to and receive permission request response suggestions from the recommendation server. In FIG. 1, mobile client device 130 (also referred to herein as “mobile client”, “mobile computing device” or “mobile device”) is attempting to install an app 104 from a market place such as one of the app market places 120. Mobile client device 130 can determine which permissions that app 104 wishes to have and query recommendation server 140. Mobile client device 130 can receive recommendations about requested app permissions from recommendation server 140 and send back information regarding which permissions were granted via permission responses 108. Recommendation server 140 can query app market places 120 as well as any internal information it may contain on app 104 to determine what permission recommendations to send to mobile devices. App market places 120 can send back information about app 104 in app ranks 102. The recommendation server 140 may also send ranking information to the app market places 120 once it receives permission responses 108 from mobile devices.

Recording the users' responses and providing decision recommendations to users are useful for generating better recommendations in the mobile device app recommendation system. In the system, a recommendation server such as recommendation server 140 can record the responses to which permissions are granted to apps, and also compute recommendations according to the recorded responses from users. Mobile devices may request recommendations from the recommendation server when needed.

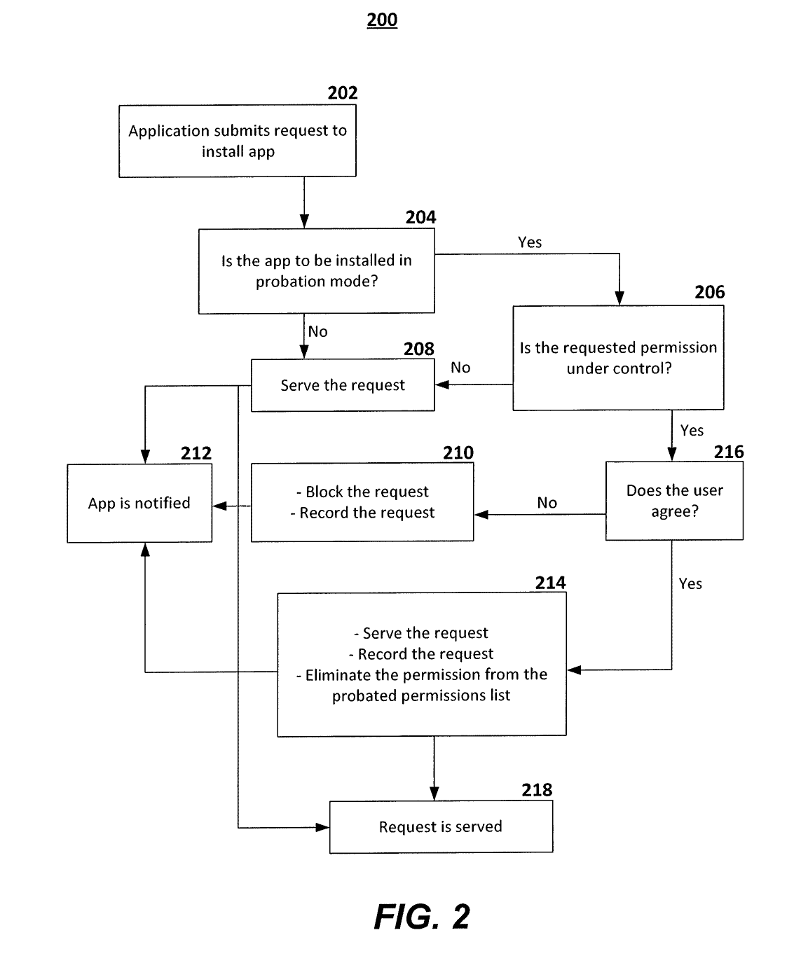

FIG. 2 illustrates a flow diagram 200 showing operations for permission checking and granting, according to an example implementation of the disclosed technology. In the first installation of an app at 202, the system allows the app to be installed on one of the two modes, either trusted or probation mode, at 204. If the app is to be installed in trusted mode, then at 208, the request to install the app is served (see also 218). Additionally, the app is notified at 212, and all requested permissions will be permanently granted to the app as specified by the user, if trusted mode was selected. Otherwise, the app will be installed in probation mode. At 206, the system checks to determine whether the app requires any permissions. If no permissions are required, then at 208, the request to install the app is served, the app is notified at 212, and all requested permissions will be permanently granted to the app as specified by the user.

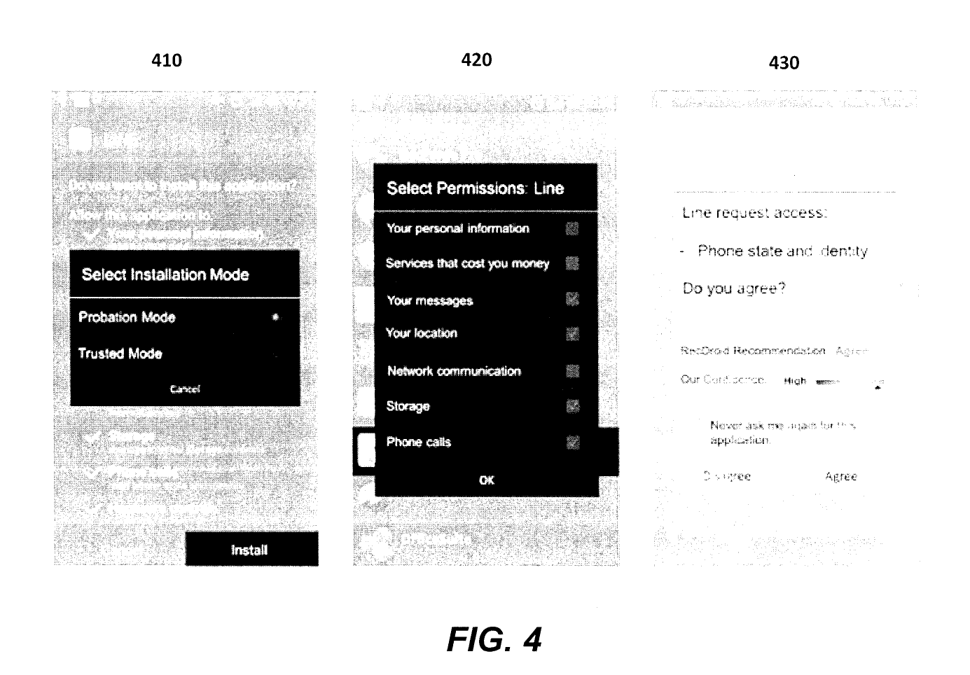

If at 206, permissions are required, then at 216 the user is queried for whether they agree to all of the requested permission. The requested permissions can be compared against a predefined list of critical permissions that are of concern to users, such as location access, contact access, and messaging functions. Regarding the installation mode selection, the system may also recommend an installation mode to the users based on collected data. For example, for new apps and apps that frequently receive rejections on permission requests, a probation installation mode should be recommended to users. With critical permissions, a mobile client can query the recommendation server to get response recommendations for the permissions, specifically for the apps to be installed. Upon receiving the answer from the recommendation service, the mobile client can display a request to the user (e.g., as a pop-up), combined with the suggested response, as shown in 430 in FIG. 4.

Based on the suggested response, the user may decide to grant or deny permission to access a certain resource. If a user chooses to deny a request, a dummy data or null may be returned to the application. For example, a denied GPS location request could be responded with a random location. At 210, the request for that particular permission is blocked, and a record of blocking that permission request is recorded. That decision may be both recorded in the mobile client and populated back to the recommendation server for app ranking and analysis.

If the user does agree to the permissions, then at 214, the installation request is served, the request is recorded, and the permission is removed from a list of list of critical permissions, and at 218 the request is served. The request may then be forwarded to legacy permission handler on the mobile client for book keeping and minimizing the system's unexpected impact on legacy apps. It is important to note that in some embodiments, this process should only happen once, when an app is first installed. Later, after collecting user's responses and preferences, and having a security and privacy ranking of the app, the recommendation server may decide and notify mobile clients whether to display permission requests or automatically answer them based on prior knowledge.

The responses to permission requests from all users can be logged by a recommendation server and can be used to generate recommendations to un-savvy users to help them make correct decisions to avoid unnecessary permission granting. For example, if a restaurant finding app is requesting access to the user's camera, then the request may be deemed to be suspicious and may be declined by an expert user. The responses of expert users are then aggregated and the system may suggest to other users of the same app not to accept similar requests.

### Ranking Expert Users

Ranking methodologies for seeking expert system users, in accordance with some example implementations of the disclosed technology, will now be described. To suggest plausible responses to users, a system such as the system described above with respect to FIGS. 1 and 2 can start from a set of trusted seed expert users and make recommendations based on their responses. However, it may be impractical to have expert users to provide responses to all available apps on the market, due to the extremely large volume of available apps. To address this scalability challenge, searching may be conducted for external expert users based on the similarity of their responses to a set of internal experts, in combination with the user's accumulative reputation.

### Ranking Expert Users—Methodology 1

In one example implementation of the disclosed technology, a recommendation for an app may be based on the average of top expert users in combination with a response or responses that are selected by majority of participants. Certain methodologies used to search for external expert users are discussed below in connection with an exemplary spanning algorithm. It should be appreciated that the spanning algorithm discussed is one example technique that may be employed, but that other techniques may be additionally or alternatively utilized.

In one example implementation for seeking expert users, for a set of users U, among them set E⊂U is a set of initial seed expert users. For instance, security experts can be to monitor the permission requests from apps. The seed experts respond to the permission requests from selected apps based on their professional judgment. Their responses are considered accurate and are used in the system as ground truth. However, due to limited budget and manpower, the number of apps that can be covered by seed experts may be small compared to the entire app base that a system can monitor. In this example discussion, set A denotes apps that are monitored by the system.

Suppose that initially each of the seed expert users E has responded to a set of apps of their choice. The apps responded by a seed expert user eεE can be denoted by e. Since there may be multiple permission requests displayed (e.g., as pop-ups) during an app usage, (a) can be used to denote the set of requests the app aε A may have. Rₑ can be used to denote all requests that are covered by seed expert users of the system, named labeled requests, and thereby:

Rₑ=∪U∀_{eεE}∪_{∀aε(e)}R(a) (1)

To determine whether a user is expert user or not, the system may apply a ranking algorithm to evaluate the expertise level of a user based on the ratio of correctness on their responses to app requests. The probability that user pᵢ correctly responds to permission requests can be denoted by i. The system can estimate pᵢ based on the number of correct and incorrect responses that user has responded to in the past. One approach is to observe all labeled requests, those that have been reviewed by an expert that are independently responded (without recommendation) by the user, and compute the ranking of the user based on the number of correct/incorrect responses to those requests.

The notation α can be used to represent the cumulative number of requests that are responded to consistent with seed experts and β requests are responded opposite to the experts' advice (note that the labels from seed experts may arrive later than the user's responses). Furthermore, a random variable Xε{0, 1} can be used to denote whether a user answers the permission requests correctly or not, where X=1 represents that user responds to a request correctly, and vice versa. Thereby, p= [symbol] (X=1). Given a sequence of observations on X, a beta distribution can be used to model the distribution of p.

In Bayesian inference, posterior probabilities of Bernoulli variables given a sequence of observed outcomes of the random event can be represented by beta distributions. The beta family of probability density functions is a continuous family of functions indexed by the two parameters α and β, where they represent the accumulative observation of occurrence of outcome 1 and outcome 0, respectively. The beta PDF distribution can be written as:

$$f ( p \backslash α , β ) = \frac{Γ ( α + β )}{Γ ( α ) + Γ ( β )} {{p}^{a - 1} ( 1 - p )}^{β - 1} \qquad ( 2 )$$

The above can also be written as,

$$p \sim \frac{Γ ( α + β )}{Γ ( α ) + Γ ( β )} {{y}^{a - 1} ( 1 - y )}^{β - 1} \qquad ( 3 )$$

Let xₙε{0,1} be the nₜₕ observation in the past, where ε [symbol] . The accumulative observations of both correct and incorrect responses from a user after n observations can be written as:

$$\begin{matrix}\begin{matrix}{a}_{n} = {\sum }_{k = 1}^{n} {q}^{n - k} {x}_{k} + {q}^{n} {C}_{0} \\ = {x}_{n} + {qx}_{n - 1} + … + {q}^{n - 1} {x}_{1} + {q}^{n} {C}_{0}\end{matrix} & ( 4 ) \\ \begin{matrix}{B}_{n} = {\sum }_{k = 1}^{n} {q}^{n - k} ( 1 - {x}_{k} ) + {q}^{n} {C}_{0} \\ = ( 1 - {x}_{n} ) + q ( 1 - {x}_{n - 1} ) + … + {q}^{n - 1} ( 1 - {x}_{1} ) + {q}^{n} {C}_{0}\end{matrix} & ( 5 )\end{matrix}$$

where C₀ is a constant number denoting the initial belief of observations; qε└0,1┘ is the remembering parameter which is used to discount the influence from past experience and therefore emphasize the importance of more recent observations.

Equation 4 and 5 can also be written into an iterative form as follows:

α₀=β₀=C₀ (6)

αₙ=xₙ+qaₙ₋₁ (7)

βₙ=(1−xₙ)+qβₙ₋₁ (8)

Let random variable Y represent the possible value that the true expertise level of a user, such that:

$$\begin{matrix}𝔼 ⌊ Y ⌋ = \frac{a}{a + β} & ( 9 ) \\ {δ}^{2} ⌊ Y ⌋ = \frac{a β}{{( a + β )}^{2} ( a + β + 1 )} & ( 10 )\end{matrix}$$

s can be used to represent the expertise ranking of the user. s can then be computed using the following formula,

$$\begin{matrix}s = max ( 0 , 𝔼 ⌊ {Y}_{i} ⌋ - t θδ ⌊ {Y}_{i} ⌋ ) \\ = max ( 0 , \frac{a}{a + β} - t θ \frac{\sqrt{a β}}{{( a + β )}^{2} ( a + β + 1 )} ,\end{matrix} \qquad ( 11 )$$

Where tε[0,∞]∞) represents a conservation factor where a higher value means our ranking mechanism is more conservative to less confident estimation.

$$θ = \sqrt{\frac{2 - q}{1 - q}}$$

is the normalization factor, which is to decouple the forgetting factor and expertise rating.

It can be seen that the higher ratio a user responds to pe-mission requests correctly, the higher ranking score it receives through the system; the more samples the system knows about the user, the higher score it receives.

Given the ranking scores of users, a simple threshold τ can be used to identify expert users from novice users. That is, if a user sᵢ has i≧τ, then it can be labeled as an expert user. The ranking scores can be used to make recommendations to other app users when permission requests pop up.

### Response Aggregation Through Weighted Voting

Generating recommendations on app permission requests based on existing responses from other users who have used the same app will now be described according to an example implementation of the disclosed technology.

When a user receives a permission request from an app in probation mode, the system can attempt to make a recommendation to the user regarding whether they should grant the request. If the app has been investigated by one or more seed expert users, then the response from the seed experts may be recommended to the user. However, due to the limitation of seed experts, a majority of apps may not be covered by seed experts. In such case, the system can aggregate the responses from other users and app stores and recommend the aggregated response if a confidence level is high enough.

In accordance with some example implementations, an approach to aggregating responses can be accomplished through weighted voting. The voting process can be divided into three steps: qualification, voting, and decision. In the qualification step, only responses from qualified users are included into the voting process. Initially the ballot count for reception decision and rejection decision are equally initialized to D₀. For each qualified voter, the weight of the cast ballot is the ranking score of the voter. After the voting process finishes, the average ballot score is used to make a final decision. If the average ballot score exceeds a predetermined decision threshold, then corresponding recommendations are made. Otherwise, no recommendation may be made.

In this decision making process, users with higher expertise level impose higher impact to the final decisions. When there are not enough existing responses from expert users, or the responses from expert users conflict with each other, the system may choose not to make any recommendation. An example technique to generate recommendation on app permission requests based on existing responses from other users who have used the same app is given by “Algorithm 1” below.

Algorithm 1 Weighted Voting for Recommendation Decision

```
Notations:
M: the set of users who have responded to the permission question
sᵢ: the ranking of the ith user
xᵢ: the response of the ith user
τₑ : the minimum required ranking score to be classified into expert users
τ_{d}: the recommendation threshold
a, b: the cumulative ballots for reception and rejection decision
D₀: the initial ballot count for both decisions
//initialize voting parameters
a = b = D₀
for each user u in M do
  if sᵤ > τₑ then
  //only qualified users responses are considered into the voting
    if xᵤ = 1 then
    a+ = sᵤ
    else
    b+ = sᵤ
    end if
  end if
end for
//decision making based on final ballots result
$If \frac{a}{a + b} > 1 - {τ}_{d} then$
  Recommend to accept the request
$else if \frac{a}{a + b} < - {τ}_{d} then$
  Recommend to reject the request
else
  No recommendation
end if
```

### Ranking Expert Users—Methodology 2

In some example implementations, the system can be seen as a network [symbol] ={s∪ [symbol] ,}, which consists of a seed expert s, a set of n regular users [symbol] ={U₁, U₂, . . . , Uₙ}, and a set of edges ε={εᵢⱼ| [symbol] ᵢ∩ [symbol] ⱼ≠φ,∀i,j} denoting users i and j have installed apps in common, where [symbol] ᵢ denotes the set of permission requests responded by user i.

The seed expert (SE) is one or a set of trusted expert users who might be employed by a system facilitator to provide accurate responses to permission requests. It can be assumed that seed experts are fully trusted and always provide correct response to permission requests of the apps they cover. However, due to the high cost of human labor, the seed expert may only cover limited number of applications. Therefore, identifying expert users from regular users can expand the coverage of apps that can benefit from the system's recommendation.

It is noteworthy that to make seeds' responses context-independent, they can follow the principle of least privilege, which is finding a minimal set of permissions that are necessary for apps' legitimate purposes. In this way, the seeds' responses are not depend on preference or context.

Let [symbol] ₛ denote the set of requests covered by seed experts. Then the common set of requests responded by both the seed user and user i can be written as [symbol] ₛᵢ= [symbol] ₛ∩ [symbol] ᵢ. In general, the common set of requests responded by any two users i, j can be written as [symbol] ᵢⱼ= [symbol] ᵢ∩ [symbol] ⱼ. Table 1 below lists some specific notations used herein.

TABLE 1
Notations

| Notation | Description |
|---|---|
| [symbol] | { [symbol] ₁, . . . , [symbol] }: Set of [symbol] users in the system. |
| [symbol] | The seed user set. |
| [symbol] | The set of requests responded by user [symbol] in the past. |
| [symbol] | The true expertise level of user [symbol] . |
| [symbol] , [symbol] | The expertise rating and confidence of user [symbol] . |
| (α_{i,j}, βᵢⱼ) | The similarity tuple between user i and j. |
| (αᵢ, βᵢ) | The expertise level distribution parameters for user i |

A key challenge is to seek experts from the regular users such that the system can make low-risk recommendations based on the responses from those expert users. The expertise level of a user i, denoted by pᵢ ε[0,1], is the likelihood that the user makes correct permission granting decisions. Given the set of responses that user i has given to permission requests and their corresponding ground truth, a Bayesian inference model can be used to estimate pᵢ.

Assuming the likelihood that a user i makes correct decision (pᵢ) satisfies a distribution Yᵢ with pdf fᵢ(x), then the expected expertise level of the user can be defined to be:

Rᵢ= [symbol] [Yᵢ]=∫ₓ₌₀¹xfᵢ(x)dx

The confidence level of the estimation is:

$${C}_{i} = 1 - {θ ( {\int }_{x = 0}^{1} {( x - {R}_{i} )}^{2} {f}_{i} ( x ) d x )}^{1 / 2}$$

where θ is the normalization factor. Therefore, the expertise seeking problem can be described as follows.

Given a seed user s and a set of users={U₁, . . . , Uₙ}, a graphical representation can be denoted as [symbol] ={ [symbol] ∪,ε}, where ε=(eᵢⱼ| [symbol] ᵢ∩ [symbol] ⱼ≠φ, ∀i, j} is a set of edges between users where they have overlap on responded requests. The expertise rating problem is to find the posterior distributions of all pᵢ, given their past history of responding to permission requests.

Supposing user i and user j have responded to a common set of permission requests [symbol] ᵢⱼ, then the similarity between these two users can be defined using a similarity tuple (αᵢⱼ, βᵢⱼ), denoting the accumulated number of consistent responses and inconsistent responses to those common requests, respectively.

Let {xᵢ ε{0,1}|1≦k≦n} denote a sequence of n observations in history, where xₖ=1 means the two users provided consistent responses at the kth overlapped request, and vice versa. The similarity tuple can be computed as follows:

$$\begin{matrix}\begin{matrix}{α}_{ij}^{( n )} = {\sum }_{k = 1}^{n} {q}^{n - k} xk + {q}^{n} {C}_{0} \\ = {x}_{n} + {qx}_{n - 1} + … + {q}^{n - 1} {x}_{1} + {q}^{n} {C}_{0}\end{matrix} & ( 12 ) \\ \begin{matrix}{β}_{ij}^{( n )} = {\sum }_{k = 1}^{n} {q}^{n - k} ( 1 - {x}_{k} ) + {q}^{n} {C}_{0} \\ = ( 1 - {x}_{n} + q ( 1 - {x}_{n - 1} ) + … + {q}^{n - 1} ( 1 - {x}_{1 )} + {q}^{n} {C}_{0}\end{matrix} & ( 13 )\end{matrix}$$

where C₀ is a constant weighting the initial belief; qε[0, 1] is the remembering factor which is used to discount the influence from past experience and therefore emphasize the importance of more recent observations.

Starting with the case that a user i who has a common set of responded requests with the seed expert, in such case, the similarity tuple (αₛᵢ, βₛᵢ) between the user and the seed can be computed, and then the distribution of pᵢ based on the observations.

Let i be a user i that has only one seed expert neighbor. Let (αₛᵢ, βₛᵢ) be the similarity tuple of i and the seed expert. Then the rating of the user can be estimated as follows:

$$\begin{matrix}{R}_{i} = \frac{{α}_{si}}{{α}_{si} + {β}_{si}} & ( 14 ) \\ {C}_{i} = 1 \sqrt{\frac{12 {α}_{si} {β}_{si}}{{( {α}_{si} + {β}_{si} )}^{2} ( {α}_{si} + {β}_{si} + 1 )}} & ( 15 )\end{matrix}$$

Since the seed expert's advice is assumed correct, α and β are indeed the number of correct and incorrect responses that the user answered in the past. Let a random variable X ε {0, 1} denote whether a user answers the permission requests correctly or not. X=1 indicates that user responds to a request correctly, and vice versa. Therefore, p= [symbol] (X=1). Given a sequence of observations on X, a beta distribution can be used to model the distribution of p.

In Bayesian inference theory, posterior probabilities of Bernoulli variables given a sequence of observed outcomes of the random event can be represented by beta distributions. The beta-family of probability density functions is a continuous family of functions indexed by the two parameters α and β, where they represent the accumulative observation of occurrence of outcome 1 and outcome 0, respectively. The beta PDF distribution can be written as:

$$f ( p \vert α , β ) = \frac{Γ ( α + β )}{Γ ( α ) Γ ( β )} {{p}^{a - 1} ( 1 - p )}^{β - 1} \qquad ( 16 )$$

The above can also be written as,

$$p \sim \frac{Γ ( α + β )}{Γ ( α ) Γ ( β )} {{y}^{a - 1} ( 1 - y )}^{β - 1} \qquad ( 17 )$$

Due to the potentially limited coverage of the seed user, there may be many users who do not have direct overlap with the seed user. To rate users who are connected only to a regular user with known expert rating, the following approach can be used.

Let i be a user connected to a user u with known expertise level pᵤ>½ in the graph; let (αᵤᵢ, βᵤᵢ) be the similarity tuple of i and u, where αᵤᵢ≧βᵤᵢ. Then pᵢ satisfies a beta distribution: pᵢ˜Beta(αᵢ, βᵢ), where

$$\begin{matrix}{a}_{i} = \frac{{α}_{ui} {p}_{u} + {β}_{ui} ( {p}_{u} - 1 )}{2 {p}_{u} - 1} & ( 18 ) \\ {β}_{i} = \frac{{α}_{ui} ( {p}_{u} - 1 ) + {β}_{ui} {p}_{u}}{2 {p}_{u} - 1} & ( 19 )\end{matrix}$$

Let random variables Xiε{0, 1} and Xᵤε{0, 1} denote a random event that user i and u respond to permission requests correctly or not. Xᵢ(Xᵤ)=1 means that user i(u) responds to a permission request correctly. Therefore, pᵢ= [symbol] (Xᵢ=1) and pᵤ= [symbol] (Xᵤ=1). Using Bayesian theory, the probability that a consistent response is a correct response is formulated as follows:

$$\begin{matrix}ℙ ( {X}_{i} = 1 \vert {X}_{i} \neq {X}_{u} ) = \frac{ℙ ( {X}_{i} = {X}_{u} \vert {X}_{i} = 1 ) ℙ ( {X}_{i} = 1 )}{ℙ ( {X}_{i} = {X}_{u} )} \\ = \frac{ℙ ( {X}_{u} = 1 \vert {X}_{i} = 1 ) ℙ ( {X}_{i} = 1 )}{ℙ ( {X}_{i} = 1 , {X}_{u} = 1 ) + ℙ ( \begin{matrix}{X}_{i} = {X}_{i} = 0 , \\ {X}_{u} = 0\end{matrix} )} \\ = \frac{ℙ ( {X}_{u} = 1 ) ℙ ( {X}_{i} = 1 )}{\begin{matrix}ℙ ( {X}_{i} = 1 ) , ℙ ( {X}_{u} = 1 ) + ℙ ( {X}_{i} = 0 ) \\ ℙ ( {X}_{u} = 0 )\end{matrix}} \\ = \frac{{p}_{i} {p}_{u}}{{p}_{i} {p}_{u} + ( 1 - {p}_{i} ) ( 1 - {p}_{u} )}\end{matrix} \qquad ( 20 )$$

Similarly, the probability that an inconsistent response being a correct response is formulated as follows:

$$\begin{matrix}ℙ ( {X}_{i} = 1 \vert {X}_{i} \neq {X}_{u} ) = \frac{ℙ ( {X}_{i} = {X}_{u} \vert {X}_{i} \neq 1 ) ℙ ( {X}_{i} = 1 )}{ℙ ( {X}_{i} \neq {X}_{u} )} \\ = \frac{{p}_{i} ( 1 - {p}_{u} )}{{p}_{i} ( 1 - {p}_{u} ) + ( 1 - {p}_{i} ) {p}_{u}}\end{matrix} \qquad ( 21 )$$

Note that αᵢ and βᵢ denote the cumulative observations that user i responds correctly. Then αᵢ and βᵢ can be obtained indirectly from αᵤᵢ and βᵤᵢ from the formula below,

αᵢ=αᵤᵢ [symbol] (Xᵢ=1|Xᵢ=Xᵤ)+βᵤᵢ [symbol] (Xᵢ=1|Xᵢ≠Xᵤ)

βᵢ=αᵤᵢ [symbol] (Xᵢ=0|Xᵢ=Xᵤ)+βᵤᵢ [symbol] (Xᵢ=0|Xᵢ≠Xᵤ)

The above equation set can be transformed into:

$$\begin{matrix}{α}_{i} = \frac{{α}_{ui} {p}_{i} {p}_{u}}{{p}_{i} {p}_{u} + ( 1 - {p}_{i} ) ( 1 - {p}_{u} )} + \frac{{β}_{ui} {p}_{i} ( 1 - {p}_{u} )}{{p}_{i} ( 1 - {p}_{u} ) + ( 1 - {p}_{i} ) {p}_{u}} & ( 22 ) \\ {β}_{i} = \frac{{α}_{ui} ( 1 - {p}_{i} ) ( 1 - {p}_{u} )}{{p}_{i} {p}_{u} + ( 1 - {p}_{i} ) ( 1 - {p}_{u} )} + \frac{{β}_{ui} {p}_{i} ( 1 - {p}_{i} )}{{p}_{i} ( 1 - {p}_{u} ) + ( 1 - {p}_{i} ) {p}_{u}} & ( 23 )\end{matrix}$$

Note that the estimated expertise level of user i can be written as

$${ℛ}_{i} = ( \frac{{α}_{i}}{{α}_{i}} + {β}_{i} ) .$$

However, the actual expertise level pᵢ of user i is unknown. An iterative method can be used to iteratively update Equations (22) and Equation (23) starting from [symbol] ᵢ^{(t-1)}=½ and at each round t replaces pᵢ with the last round expertise level [symbol] ᵢ^{(t-1)}. The process stops when [symbol] ᵢ^{(t)} converges. Alternatively, Equation set (22) and (23) can be solved by replacing pᵢ with αᵢ/(αᵢ+βᵢ). Then (16) and (17) are obtained.

Since not all users are connected to the seed user, a rating propagation model can be called upon to rate users who are indirectly connected to the seed. User i has overlap with the seed user, so it can be ranked through a Bayesian ranking algorithm. User j only has overlap with user i, so it can be ranked based on its similarity to user i. Therefore, here an iterative method is used to update the rating of all regular users in the system.

Let i be a regular user directly connected to a set of users [symbol] . The ratings or the neighbors at round t are (αᵢ^{t}, βᵢ^{t}), then the rating tuple (αᵢ^{(t+1)}, βᵢ^{t+1)}) of user i at time t+1, can be computed as follows:

$${α}_{i}^{( 0 )} = {β}_{i}^{( 0 )} = 1 , ∀ i , s . t . {U}_{i} ∈ 𝒰 \\ {α}_{i}^{( t + 1 )} = ( \frac{{α}_{ik} {α}_{i}^{( t )} {α}_{k}^{( t )}}{{α}_{i}^{( t )} {α}_{k}^{( t )} + {β}_{i}^{( t )} {β}_{k}^{( t )}} + \frac{{β}_{ik} {α}_{i}^{( t )} {β}_{k}^{( t )}}{{α}_{i}^{( t )} {β}_{k}^{( t )} + {α}_{k}^{( t )} {β}_{i}^{( t )}} ) \\ {β}_{i}^{( t + 1 )} = ( \frac{{α}_{ik} {β}_{i}^{( t )} {β}_{k}^{( t )}}{{α}_{i}^{( t )} {α}_{k}^{( t )} + {β}_{i}^{( t )} {β}_{k}^{( t )}} + \frac{{β}_{ik} {α}_{k}^{( t )} {β}_{i}^{( t )}}{{α}_{i}^{( t )} {β}_{k}^{( t )} + {α}_{k}^{( t )} {β}_{i}^{( t )}} ) \qquad ( 24 )$$

From Equation (22) and (23) it is shown that the rating of a node can be computed using the similarity with a source of known rating. (αᵢ^{(k)},βᵢ^{(k)}) can be used to denote the transformed observation on user i passed by user k, and then:

$$\begin{matrix}{α}_{i}^{k} = \frac{{α}_{ik} {p}_{i} {p}_{k}}{{p}_{i} {p}_{k} + ( 1 - {p}_{i} ) ( 1 - {p}_{k} )} + \frac{{β}_{ik} {p}_{i} ( 1 - {p}_{k} )}{{p}_{i} ( 1 - {p}_{k} ) + ( 1 - {p}_{i} ) {p}_{k}} \\ {β}_{i}^{k} = \frac{{α}_{ik} ( 1 - {p}_{i} ) ( 1 - {p}_{k} )}{{p}_{i} {p}_{k} + ( 1 - {p}_{i} ) ( 1 - {p}_{k} )} + \frac{{β}_{ik} {p}_{i} ( 1 - {p}_{i} )}{{p}_{i} ( 1 - {p}_{k} ) + ( 1 - {p}_{i} ) {p}_{k}}\end{matrix}$$

By replacing pᵢ with

$$\frac{{α}_{i}}{{α}_{i} + {β}_{i}}$$

and pₖ with

$$\frac{{α}_{k}}{{α}_{k} + {β}_{k}}$$

we have:

$$\begin{matrix}{α}_{i}^{k} = {α}_{ki} \frac{{α}_{k} {α}_{i}}{{α}_{k} {α}_{i} + {β}_{k} {β}_{i}} + {β}_{ki} \frac{{β}_{k} {α}_{i}}{{β}_{k} {α}_{i} + {α}_{k} {β}_{i}} , ∀ k ∈ \{ 1 , 2 , … , m \} \\ {β}_{i}^{k} = {α}_{ki} \frac{{β}_{k} {β}_{i}}{{α}_{k} {α}_{i} + {β}_{k} {β}_{i}} + {β}_{ki} \frac{{α}_{k} {β}_{i}}{{β}_{k} {α}_{i} + {α}_{k} {β}_{i}} , ∀ k ∈ \{ 1 , 2 , … , m \}\end{matrix}$$

In Bayesian inference theory, the observations on one variable can be cumulated through simple summation on all observations, given that they are observed independently. In this case the rating of a user can be represented by the total number of positive and negative observations observed by connected users on different paths. Given that αᵢ and βᵢ represent the cumulative positive/negative observations on user i, then:

$${α}_{i} = {α}_{i}^{1} + … {a}_{i}^{m} = {\sum }_{k = 1}^{m} {a}_{i}^{k} \\ {β}_{i} = {β}_{i}^{1} + … {β}_{i}^{m} = {\sum }_{k = 1}^{m} {β}_{i}^{k} \qquad ( 25 )$$

A user may have overlap with multiple other users. The overlap with multiple users can be seen as observations from multiple sources and those observations can be aggregated to generate a more accurate ranking of user i.

Let i be a user who has overlap with a set of users M={U₁, U₂, . . . , Uₘ} with corresponding similarity tuples S={(αₗᵢ, βₗᵢ), . . . , (αₘᵢ, βₘᵢ)}. Then,

$${α}_{i} = {α}_{i}^{1} + … {a}_{i}^{m} = {\sum }_{k = 1}^{m} {a}_{i}^{k} \\ {β}_{i} = {β}_{i}^{1} + … {β}_{i}^{m} = {\sum }_{k = 1}^{m} {β}_{i}^{k} \\ where , {α}_{i}^{k} = {α}_{ki} \frac{{α}_{k} {α}_{i}}{{α}_{k} {α}_{i} + {β}_{k} {β}_{i}} + {β}_{k i} \frac{{β}_{k} {α}_{i}}{{β}_{k} {α}_{i} + {α}_{k} {β}_{i}} , ∀ k ∈ \{ 1 , 2 , … , m \} \\ {β}_{i}^{k} = {α}_{ki} \frac{{β}_{k} {β}_{i}}{{α}_{k} {α}_{i} + {β}_{k} {β}_{i}} + {β}_{k i} \frac{{α}_{k} {b}_{i}}{{β}_{k} {α}_{i} + {α}_{k} {β}_{i}} , ∀ i ∈ \{ 1 , 2 , … , m \} \qquad ( 26 )$$

This results by iteratively computing αᵢ and βᵢ on node i in a graph starting from initial setting αᵢ⁽⁰⁾=1 and βᵢ⁽⁰⁾=1.

The approach to define the order of user rating is to start from the direct neighbors of the seed expert, and then the list is expanded by looking for the next hop users, and so on. An iterative algorithm is described in Algorithm 2 which rates all regular users in the system. It should be appreciated that Algorithm 2 is one example technique that may be employed, but that other techniques may be additionally or alternatively utilized. In accordance with one example implementation, the iteration stops when the difference between two rounds of ratings are sufficiently close.

Algorithm 2 Rate All Regular Users

Compute expertise rating of all regular users
Notations:
R( [symbol] ): the current rating of all users [symbol]
( [symbol] ): the last round of rating of all users
s: the seed expert [symbol]
ᵢ: the iₜₕ user
G = (V, E): the generated graph of users and overlaps
RU: the set of rated users
QU: the queue of users to be rated
// parameters initialization
set R(s) = 1 and R(U) = 0.5
while (Distance(R(U), [symbol] ( [symbol] )) > ε do

```
  RU ← s
  QU ← findNeighbors(s) [symbol]
  (U) ← R(U)
  while (u ← remove(QU) is not null) do
```

R(u) ← computeRating(u)
RU ← RU ∪ u
N = findNeighborsNotInRUorQU(u, G)
push(N, QU)

end while

end while

Algorithm 3 Vote for Recommendation

```
Notations:
R(u), C(u): the rating score and confidence of user u
x(u): the response to permission request from user u
τₑ, τ_{c}: the minimum rating score and rating confidence to be considered
as an expert user
τ_{d}: the recommendation threshold
a, b: the cumulative ballots for yes or no decision
D₀: the initial ballot count for both decisions
a = b = D₀
//User filtering and ballots casting
for each user u who responded to the request do
  if R(u) > τₑ and C(u) > τ_{c}, then
    if x(u) = 1 then
      a+ = R(u)
    else
      b+ = R(u)
    end if
  end if
end for
//decision making based on final ballots count
$if \frac{a}{a + b} > {τ}_{d} then$
  $Recommend to accept the request with confidence \frac{a}{a + b} - {τ}_{d}$
$else if \frac{a}{a + b} < 1 - {τ}_{d} then$
  $Recommend to reject the request with confidence 1 - \frac{a}{a + b} - {τ}_{d}$
else
  No recommendation
end if
```

A weighted voting method can handle the decision making. The voting process can be divided into three steps: qualification, voting, and decision. An example implementation is shown in Algorithm 3. It should be appreciated that Algorithm 3 is one example technique that may be employed, but that other techniques may be additionally or alternatively utilized.

In the qualification step, only responses from qualified users are included into the voting process. Initially the ballot count for reception and rejection decisions are equally initialized to D₀. For each qualified voter, the weight of the cast ballot is the ranking score of the voter. After the voting process finishes, the average ballot score is used to make a final decision. If the average ballot score exceeds a predetermined decision threshold, then corresponding recommendations are made. Otherwise, no recommendation is made.

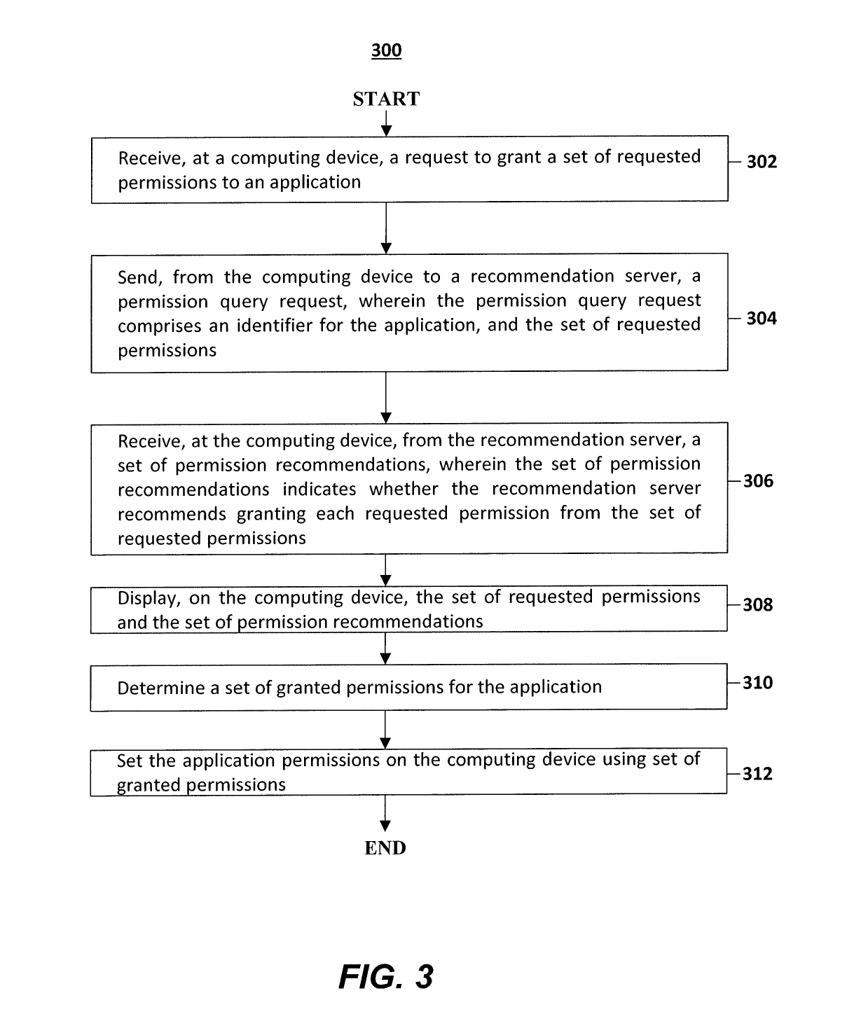

FIG. 3 is a flow diagram showing operations of a method 300 of managing application permissions, in accordance with one example implementation of the disclosed technology.

At step 302, a computing device receives a request to grant a set of permissions to an application. This application may ask for certain permissions to the operating system and peripherals of the computing device, for example the camera, phone, or user contacts stored on the computing device.

At step 304, the computing device sends a permission query request to a recommendation server, wherein the permission query request comprises an identifier for the application, and a set of requested permissions. The computing device wants to know whether it is safe to grant the permissions to the application on the computing device.

At step 306, the computing device receives a reply from the recommendation server, which includes a set of permission recommendations. The set of permission recommendations indicates whether the recommendation server recommends granting each requested permission from the set of requested permissions. The recommendation server has queried its own database and potentially other sources of data like app stores to make recommendations in regards to the desired permissions for the particular application.

At step 308, the computing device takes the set of requested permissions and the set of permission recommendations and displays them (e.g., on a display screen of the computing device). The permissions may be selected or not or have some other values based on the response from the recommendation server. FIG. 4 at 420 shows an example of displaying permissions on a mobile computing device.

At step 310, the computing device determines a set of granted permissions for the application. This can be based on the set of recommendations received from the recommendation server in whole, part, or not at all.

At step 312, the set of granted permissions for the application are set on the computing device using the permissions from the set of granted permissions just determined. The computing device user's desired permissions are set for the application permissions.

The computing device can also send to the recommendation server the set of granted permissions, such that the recommendation server can update what permissions have been granted for particular applications. The server can aggregate this data into a database to be used in further recommendations. In this way the server is crowdsourcing permission data from multiple sources including at least app stores, expert users, and application users.

### Mobile Operating System

A system implementation process in accordance with some example implementations of the disclosed technology will now be described. A goal of the system can be to provide a platform for users to grant permissions to apps based on recommendations from expert users. To implement such a system, the permission management component of a mobile operating system can be modified. In addition, the system provides users with an application to monitor and manage resource access permissions at fine-grain level. FIG. 1 depicts an example system's implementation architecture and modified and attached components to the mobile operating system.

To implement a real-time resource permission control, the system can be designed to capture all resource access requests (system calls) at run-time. To achieve this goal, a software patch to modify the mobile operating system, where a few components and methods are changed, may be installed.

The modifications to the mobile operating system can allow the system to prompt users on whether they would like an application placed into probation mode. This is an activity that is spawned off by the OS. The user can be presented with two choices: trusted and probation (untrusted) installation. If the user selects trusted mode installation, then the application is not managed by the system, and no information is recorded about the application within the system related repositories. If the user selects probation mode, then the application UID used by the mobile operating system, all permissions requested by the app that the system is probating are recorded. The modification is presented in the form of a patch to the mobile operating system, which can be executed from a user's space, making this technique easier to adopt.

A part of communication with an application layer may be users' interactions. The communication can be made through prompting a user by generating a pop-up type display. Such transactions may include presenting user interfaces (e.g., pop-ups and recommendations), receiving input from user interfaces (e.g., collecting responses to permission requests from users), managing (e.g., defining policies) requested permissions from users, and app installation mode selection by users.

Users of the system have the option to install apps under a probation mode. FIG. 4 provides screen shots from a display of a computing device, showing an example of installing an app on a mobile device using the system, and the options presented to a mobile user. The desired installation of the app “Line” (a popular chat application) is used as an example. At 410, two options are displayed for installing the app on the mobile device. The user can select either probation mode or trusted mode. If the user selects trusted mode, the app will be installed with all requested permissions granted. If the user selects the probation mode, the application will be added to a list of monitored apps on the phone.

At 420, if the user has selected probation mode, a list of permissions is presented for the user to either allow or deny. The user may check which boxes to allow permission for. The list of permissions can be queried from a permission server.

For each installed app, a user can use the system application to view a list of applications which have been installed under the probation mode. If the user selects an application in the list, a set of its requested permissions will be listed and the user can select some of them to be monitored resources. At 420, this list of permission is shown and can be modified. By default, all sensitive resources can be listed to be monitored. If an app is installed under probation mode, whenever the app requests to access to a sensitive resource under monitoring, the user will be informed. This can be seen at 430, where “Phone state and identity” is a sensitive resource, and the user is queried as to whether to allow the app to access the resource. The recommendation server may be queried for its recommendation regarding the app and permission(s) requested. In 430, the recommendation server has provided a high confidence in this requested permission for this app.

### Malicious App and User Detection Using a Game Theoretical Model

Malicious users may want to compromise a recommendation system. For example, the owner of a malicious app (attacker) may want the app to be installed and their resource requests accepted by inexperienced users. In order to do so, the malicious app owners may choose to compromise the recommendation system by misleading the recommendation system using malicious expert users. The strategy of attack can include at least the following.

An attacker may create multiple malicious new users (fraudulent users). A recommendation system can use a phone ID as user identification, thus creating each new user can require a new phone. This step can bring certain money costs to an attacker.

Each phone could then need to install a number of apps and response resource requests from them objectively in order to increase and obtain its expertise level from a recommendation system. Since a recommendation system may use expert users' responses for its recommendation, malicious users reaching expert level ranking may influence the recommendation system. This step requires certain effort cost to an attacker.

After all users under control are trained to be experts, they may install the one malicious app and respond to the resources requests dishonestly to mislead a recommendation system. To minimize the cost of a successful attack, the previous stay can be launched as soon as the malicious app is released to public. This is because when an app has been installed by many other regular expert users, the influence from a few malicious expert users can be reduced due to the voting mechanism that the recommendation system adopts to make decisions.

In order to reduce the influence from malicious users, a recommendation system in accordance with example implementations of the disclosed technology can have a malicious user detection function. In the detection step, the recommendation system can detect the type of users (malicious or normal) based on the users' behavior in responding to resource requests. There are at least two options for the system to perform malicious user detection: one is a machine-learning-based (ML) approach and the other is a human-based approach. The ML approach can use the similarity among malicious users in terms of their behaviors and labels malicious users if they are adequately similar to known malicious users in terms of behavior. For example, if they were created at around the same time, installed similar set of apps, and they have similar responses to app requests. Compared to human verification, ML-based detection can cost much less and can be more efficient. However, malicious users may be created without sharing much commonality, in which case a human-based verification approach using human labor to manually verify responses to app requests and compare them with the responses from other users may be additionally used. This may assist in discovering malicious users, and disrupting or stopping attacks. The human-based approach may have much lower false-positive rate and false-negative rate compared to the ML-based approach. However, the cost of a human verification approach may be much higher.

In some example implementations, a recommendation system can take responses from expert users (normal or malicious) and make recommendations to new users regarding whether to grant access to requests or not. If a ML-based detection method is used, then the recommendation system can compare the similarity among users of an app and raise alarms if suspicious malicious users are found. These malicious users and their responses can be removed from the recommendation system. If a human-based approach is used, the ground truth of responses can be revealed and dishonest malicious users can be discovered. Malicious user detection methods may bring false-positives and false-negatives in addition to extra cost to the recommendation system.

In game theory, a Bayesian game is a type of game in which information about features of the other players (e.g., payoffs) is incomplete. Although any given player does not know the private information of an opponent (e.g., payoffs), the given player may have some beliefs about what the opponent knows, and it can be assumed that these beliefs are common knowledge. For example, in card games, players can have incomplete information about the other players' cards. Instead, players consider a probabilistic distribution over the incomplete information.

A static Bayesian game can be modeled by introducing a node called ‘Nature’ as a player in a model. Nature relegates a random variable to each player which can take values of types for each player of game and associates probabilities or a probability density function with those users' types (in the course of the game, Nature randomly chooses a type for each player according to the probability distribution across each player's type space).

Considering features of recommendation systems in accordance with one or more implementations as described above, the users (clients) and services, modeling the framework by designing a Bayesian game formulation can be a feasible and effective solution. A concept behind the Bayesian game solution is that generally an attacker/defender game is an incomplete information game where the defender is uncertain about the opponent's type (normal or malicious). A Bayesian game theoretical model can provide a defender with a framework to choose their strategies based on their belief about their opponent's type.

In the recommendation system, there can be multiple types of users, including malicious and regular users. Detecting malicious users can be a critical task for the recommendation system. Since one attacker can create multiple malicious users, the recommendation system can play with either an attacker or a normal user. To study the interaction between a recommendation system and users, a two-player static Bayesian game to model the behaviors of both parties can be used. The static Bayesian game can have two players: the recommendation system users and the recommendation system framework. The recommendation system users have private information about their types and the types are unknown to the recommendation system. However, the type of the recommendation system framework is a common knowledge to all players (system and users).

An attacker player can have at least two strategies: Attack and Not attack, when sending responses to permission requests from an app. The regular user has only one strategy: Not Attack. When the Attack strategy is used, the attacker can manipulate all malicious users to respond dishonestly to permission requests from an app. For example, malicious expert users accept all malicious resource requests from an app, in order to mislead a recommendation system into wrong recommendations.

A recommendation system in accordance with some example implementations of the disclosed technology can have at least three strategies: Human Verification, ML Verification, and No Verification. When the No Verification strategy is used, the recommendation can make a recommendation based on all experts' responses without caring whether those responses are from malicious users or not. When ML verification is selected, the recommendation system can use a machine learning approach to detect suspicious malicious users who are controlled by one or more attackers, and those responses from suspicious users will not be considered by the recommendation system. When human verification is chosen, a human expert can manually respond to permission requests from an app. ML verification can be based on collected responses from users. In an ML verification system, users' responses can be considered as response history in order to assess the risk of considering responses in the recommendations. If assessed risk is high the response will be ignored with high probability and accepted if the risk is low. In this way, malicious users' responses may not be considered and an attack may fail. Although human verification can be the most accurate verification strategy in the system, it can require extra cost to the defender side due to human labor.

In order to track the payoffs of players in the game, let ω₁ denote the security value of an attacker, which is the gain of the attacker by performing a successful attack. For example, after a successful attack to a recommendation system, a number of extra users accept malicious requests and it can bring ω₁ extra profit through the attack. Let ω₂ denote a security value of the recommendation system, which can be the gain of a successful recommendation or the loss if compromised. For example, if the recommendation system does not detect this behavior, the recommendation system can make incorrect recommendations regarding the app and can lose cₐ of its security value, which can be the loss of reputation by making wrong recommendations to users. If the recommendation system successfully detects attacks and removes malicious users, it gains reputation and is can be assumed that the gain is also ω₂.

TABLE 2
Payoff matrices (Recommendation System, Users)

| | | |
|---|---|---|
| ML Detection | Human Verification | No Detection |

(a) Player i is malicious

| | | | |
|---|---|---|---|
| Attack | (1 − αₘ)ω₁ − cₐ, | (1 − αₕ)ω₁ − cₐ, | ω₁ − cₐ, −ω₂ |
| | (αₘ − 1)ω₂ − cₘ | (αₕ − 1)ω₂ − cₕ | |
| Not Attack | 0, −βₘω₂ − cₘ | 0, −βₕω₂ − cₕ | 0, 0 |

(b) Player i is regular

| | | | |
|---|---|---|---|
| Not attack | 0, −βₘω₂ − cₘ | 0, −βₕω₂ − cₕ | 0, 0 |

Table 2 depicts the matrices of payoffs of a two-player game in normal form game style. In the payoff matrices, αₘ and βₘ indicate the detection rate (true-positive) and false alarm rate (false-positive) of the recommendation system by using machine-learning detection, and αₘ,βₘε[0, 1]. The cost of using machine detection is assumed to be negligible (i.e., Cₘ=0). It is also assumed that human experts are reliable so that their decisions are consistently correct (i.e., αₕ=1 βₘ=0). ω₁ω₂ are the security values previously mentioned. The cost of attacking and human verification are denoted by cₐ and cₕ, where cₐ, cₕ>0. For example, an attacker may need to spend cₐ amount of money to purchase a number of smart phones and spend time to set them up into malicious mode to be able to influent the recommendation system. The recommendation system may need to pay a seed expert cₕ amount of compensation to verify correct responses to the permission requests from an application, in order to detect attacks. It is also assumed that ω₁, ω₂ are greater than cₐ, cₕ, since otherwise the attacker may not have incentive to attack and the recommendation system has no incentive to use human verification, respectively.

Table 2(a) describes the payoff matrices of the recommendation system and attackers, in accordance with some example implementations of the disclosed technology. It can be seen that the expected gain for the recommendation system in (Attack, ML Detection) strategy combination is: −(1−αₘ) ωₜ=(αₘ−1)ω₂, in which (1−αₘ) is the false-negative rate and the same for the attacker's payoff. This can be explained as: if the ML detector does not detect attack, then the recommendation system can generate an incorrect recommendation and can lose reputation. When the attacker chooses the Not Attack strategy, the payoff for the attackers can be always 0 and the recommendation system's payoff depends on the false-positive rate and detection cost, in the ML Detection and Human Verification cases, respectively.

Table 2(b) shows the payoff matrices for the recommendation system and regular users, in accordance with some example implementations of the disclosed technology. The payoff value for the regular user is 0 for all of the recommendation system's strategies. The recommendation system's payoff depends on the strategies played. For example, when the recommendation system plays ML Detection the payoff is −βₘω₂, which means the cost that recommendation system loses the chance to make the correct recommendation by falsely labeling some users as malicious.

An objective for all players in the game is to try to gain higher expected payoff. Attackers try to minimize the probability of being detected by recommendation system, while the recommendation system tries to detect attackers with less detection cost. The payoff of the strategies for both of the players depends on different parameters. The parameters include the false-positive and true-positive of malicious user detection or nature (N). It is worth noting that the parameter μ₀ determined by nature can have a high impact on payoffs of the players. In order to simplify the analysis, the strategies ML Detection and Human Verification are grouped into the strategy Detection and their subscripts _{h,m} are dropped.

An analysis of the Bayesian Nash equilibrium of the game under different possible circumstances follows. The μ₀ denotes the defined probabilities, by which nature node shows the prior knowledge of the system about the users.

A first possible case is when player i decides to play Attack if it is an attacker, Not Attack when it is a normal user. In this case, if the recommendation system decides to play Detection for the incoming responses from users, the recommendation system's expected payoff is as follows:

Eₚⱼ(Detection)=μ₀((α−1)ω₂−c)−(1−μ₀)(βω₂+c) (27)

and when the recommendation system decides to play No Detection the expected value would be

Eₚⱼ(NoDetection)=Eₚⱼ=−μ₀ω₂ (28)

then if

$${E}_{pj} ( Detection ) > {E}_{pj} ( NoDetection ) \\ {μ}_{0} < \frac{β {ω}_{2} + c}{( α + β ) {ω}_{2}} , \qquad ( 29 )$$

A best possible strategy for the recommendation system in accordance with one example implementation is to play Detection. In this case if the recommendation system plays Detection, then the attacker can only stay in strategy Attack if and only if

$$( 1 - α ) {ω}_{1} - {c}_{a} > 0 α < 1 … \frac{{c}_{a}}{{ω}_{1}} ,$$

which forms a Bayesian Nash Equilibrium. Therefore, under this condition, the Attack strategy for attackers, the Not Attack for regular users and Detection for the recommendation system can be one pure-strategy BNE.

In another case, if

$${μ}_{0} < \frac{β {ω}_{2} + c}{( α + β ) {ω}_{2}}$$

then the best strategy for the recommendation system is No Detection. Under this condition, the Attack strategy for attackers, the Not Attack for regular users and No Detection for the recommendation system is another pure-strategy BNE.

Another case is when an attacker plays the Not Attack and regular user plays Not Attack strategy, regardless of μ₀. The recommendation system's dominant strategy here is to play Not Verify. If the recommendation system plays No Detection, then a best strategy for the attackers is to play Attack. This strategy combination cannot be a BNE.

The above analysis shows that there is no pure-strategy BNE when

$${μ}_{0} \geq \frac{β {ω}_{2} + c}{( α + β ) {ω}_{2}} and \geq 1 - \frac{{c}_{a}}{{ω}_{1}} .$$

However, a mixed-strategy BNE for this case is possible. Let p denote the probability that an attacker plays Attack, and let q denote the probability that the recommendation system plays Detection. There is:

Eₚⱼ(Detection)=pμ₀((α−1)ω₂−c)−(1−p)μ₀(βω₂+c)−(1−μ₀)(βω₂+c) (30)

Eₚⱼ(No−Detection)=pμ₀ω₂ (31)

then by imposing

$$\begin{matrix}{E}_{pj} ( No \text{-} Detection ) = {E}_{pj} ( Detection ) \\ {p}^{*} = \frac{β {ω}_{2} = c}{( α + β ) {ω}_{2} {μ}_{0}}\end{matrix} \qquad ( 32 )$$

In order to calculate mixed-strategy for users the following is imposed

$$\begin{matrix}{E}_{pi} ( Attack ) = {E}_{pi} ( Not \text{-} Attack ) \\ {q}^{*} = \frac{{ω}_{2} = {c}_{α}}{{αω}_{1}}\end{matrix} \qquad ( 33 )$$

In summary, the mixed-strategy ((P [Attack]=p* for attackers, Not attack for regular), P[Detection]=q* for the recommendation system) under the condition that

$${μ}_{0} \geq \frac{β {ω}_{2} + c}{( α + β ) {ω}_{2}} and α \geq 1 - \frac{{c}_{α}}{{ω}_{1}} .$$

Correspondingly, the payoffs for both players at mixed-strategy BNE are:

$${E}_{pi} ( Attack ) = {E}_{pi} ( Not \text{-} Attack ) = 0 , \\ {E}_{pj} ( Detection ) = {E}_{pj} ( No Dectection ) = \frac{β {ω}_{2} + c}{α + β} \qquad ( 34 )$$

The above results show the binary condition of the defender's strategies: Detection or No Detection. However, when the strategy Detection is chosen, there can be actually two choices: ML Detection or Human Verification. A recommendation system in accordance with some example implementations can always choose the strategy that brings higher payoff for the system. From Eq. 34 there is, at the mixed strategy BNE, if

$${c}_{h} > \frac{{β}_{m} {ω}_{2}}{{α}_{m} + {β}_{m}}$$

then the human verification strategy is chosen at the mixed-strategy BNE, otherwise the ML detection strategy is chosen at the mixed BNE.

Some implications of the BNEs discussed above are as follows. When the probability of attacker is small enough,

$${μ}_{0} < \frac{{β}_{m} {ω}_{2} + c}{( {α}_{m} + {β}_{m} ) {ω}_{2}} = \frac{{β}_{m} {ω}_{2}}{( {α}_{m} + {β}_{m} ) {ω}_{2}} {μ}_{0} < \frac{{β}_{h} {ω}_{2} + {c}_{h}}{( {α}_{h} + {β}_{h} ) {ω}_{2}} = \frac{{c}_{h}}{{ω}_{2}} ,$$

then there is no incentive for the recommendation system to use any detection process for users' responses. When the probability of attacker is not small enough,

$${μ}_{0} . > min ( \frac{{β}_{m} {ω}_{2}}{( {α}_{m} + {β}_{m} ) {ω}_{2}} , \frac{{c}_{h}}{{ω}_{2}} ) ,$$

then the recommendation system should either use ML Detection or Human Verification to check the input users responses, whichever costs less.

However, in the second case, if the recommendation system plays Detection with probability

$${q}^{*} = \frac{{ω}_{1} - {c}_{α}}{α {ω}_{1}}$$

there is no profit difference whether the attacker plays attack or not attack. Therefore, there can be no incentive for attackers to perform attack in this case. Furthermore, if

$${q}^{*} > \frac{{ω}_{1} - {c}_{α}}{α {ω}_{1}}$$

then it is better off for attackers to play Not Attack. This way the recommendation system disincentivizes attackers from attacking the system.

It should be noted that that the payoff in Equation 34 is the maximum payoff the recommendation system can obtain given that the system provides disincentive for attackers to attack the system.

### Computer System Architecture

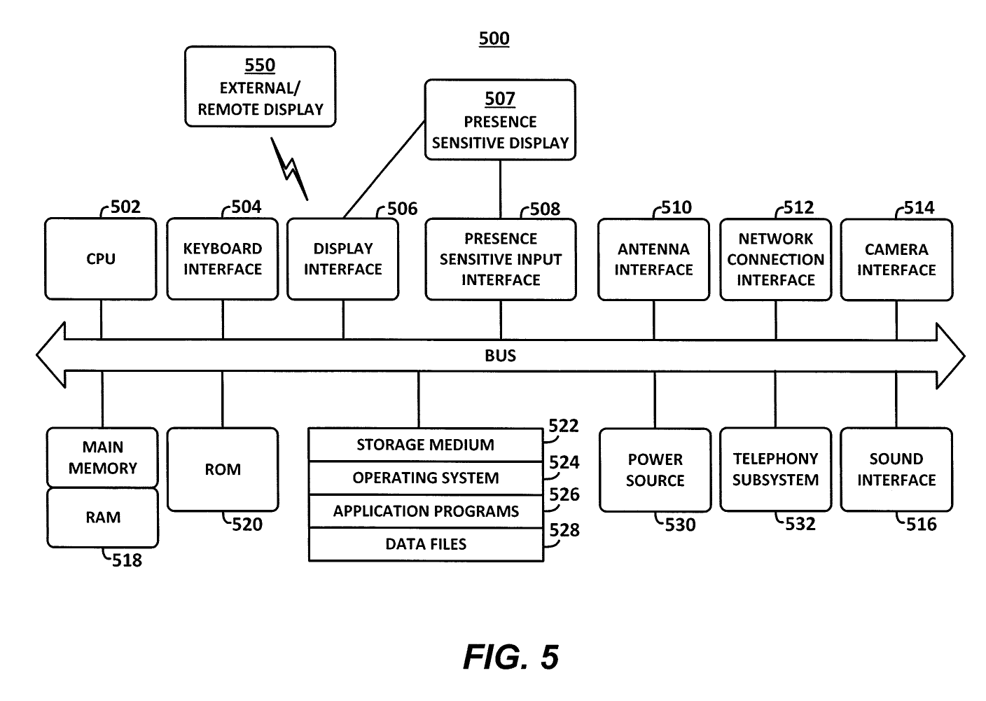

FIG. 5 depicts a block diagram showing a computer system architecture 500 according to an example embodiment. Certain aspects of FIG. 5 may be embodied in a mobile computing device. As desired, embodiments of the disclosed technology may include a mobile computing device with more or less of the components illustrated in FIG. 5. For example, the mobile client device 130 shown in FIG. 1 may include some or all of the components shown in FIG. 5. It will be understood that the computing device architecture 500 is provided for example purposes only and does not limit the scope of the various embodiments of the present disclosed systems, methods, and computer-readable mediums.

The computing device architecture 500 of FIG. 5 includes a CPU 502, where computer instructions are processed; a display interface 506 that acts as a communication interface and provides functions for rendering video, graphics, images, and texts on the display. According to certain some embodiments of the disclosed technology, the display interface 506 may be directly connected to a local display, such as a touch-screen display associated with a mobile computing device. In another example embodiment, the display interface 506 may be configured for providing data, images, and other information for an external/remote display that is not necessarily physically connected to the mobile computing device. For example, a desktop monitor may be utilized for mirroring graphics and other information that is presented on a mobile computing device. According to certain some embodiments, the display interface 506 may wirelessly communicate, for example, via a Wi-Fi channel or other available network connection interface 582 to the external/remote display.

In an example embodiment, the network connection interface 582 may be configured as a communication interface and may provide functions for rendering video, graphics, images, text, other information, or any combination thereof on the display. In one example, a communication interface may include a serial port, a parallel port, a general purpose input and output (GPIO) port, a game port, a universal serial bus (USB), a micro-USB port, a high definition multimedia (HDMI) port, a video port, an audio port, a Bluetooth port, a near-field communication (NFC) port, another like communication interface, or any combination thereof.

The computing device architecture 500 may include a keyboard interface 504 that provides a communication interface to a keyboard. In one example embodiment, the computing device architecture 500 may include a presence-sensitive display interface 507 for connecting to a presence-sensitive display. According to certain some embodiments of the disclosed technology, the presence-sensitive display interface 507 may provide a communication interface to various devices such as a pointing device, a touch screen, a depth camera, etc. which may or may not be associated with a display.

The computing device architecture 500 may be configured to use an input device via one or more of input/output interfaces (for example, the keyboard interface 504, the display interface 506, the presence sensitive display interface 507, network connection interface 582, camera interface 514, sound interface 516, etc.) to allow a user to capture information into the computing device architecture 500. The input device may include a mouse, a trackball, a directional pad, a track pad, a touch-verified track pad, a presence-sensitive track pad, a presence-sensitive display, a scroll wheel, a digital camera, a digital video camera, a web camera, a microphone, a sensor, a smartcard, and the like. Additionally, the input device may be integrated with the computing device architecture 500 or may be a separate device. For example, the input device may be an accelerometer, a magnetometer, a digital camera, a microphone, and an optical sensor.

Example embodiments of the computing device architecture 500 may include an antenna interface 580 that provides a communication interface to an antenna; a network connection interface 582 that provides a communication interface to a network. According to certain embodiments, a camera interface 514 is provided that acts as a communication interface and provides functions for capturing digital images from a camera. According to certain embodiments, a sound interface 516 is provided as a communication interface for converting sound into electrical signals using a microphone and for converting electrical signals into sound using a speaker. According to example embodiments, a random access memory (RAM) 518 is provided, where computer instructions and data may be stored in a volatile memory device for processing by the CPU 502.

According to an example embodiment, the computing device architecture 500 includes a read-only memory (ROM) 520 where invariant low-level system code or data for basic system functions such as basic input and output (I/O), startup, or reception of keystrokes from a keyboard are stored in a non-volatile memory device. According to an example embodiment, the computing device architecture 500 includes a storage medium 522 or other suitable type of memory (e.g., RAM, ROM, programmable read-only memory (PROM), erasable programmable read-only memory (EPROM), electrically erasable programmable read-only memory (EEPROM), magnetic disks, optical disks, floppy disks, hard disks, removable cartridges, flash drives), where the files include an operating system 524, application programs 526 (including, for example, a web browser application, a widget or gadget engine, and or other applications, as necessary) and data files 528 are stored. According to an example embodiment, the computing device architecture 500 includes a power source 130 that provides an appropriate alternating current (AC) or direct current (DC) to power components. According to an example embodiment, the computing device architecture 500 includes a telephony subsystem 132 that allows the device 500 to transmit and receive sound over a telephone network. The constituent devices and the CPU 502 communicate with each other over a bus 134.

According to an example embodiment, the CPU 502 has appropriate structure to be a computer processor. In one arrangement, the CPU 502 may include more than one processing unit. The RAM 518 interfaces with the computer bus 134 to provide quick RAM storage to the CPU 502 during the execution of software programs such as the operating system application programs, and device drivers. More specifically, the CPU 502 loads computer-executable process steps from the storage medium 522 or other media into a field of the RAM 518 in order to execute software programs. Data may be stored in the RAM 518, where the data may be accessed by the computer CPU 502 during execution. In one example configuration, the device architecture 500 includes at least 825 MB of RAM, and 256 MB of flash memory.

The storage medium 522 itself may include a number of physical drive units, such as a redundant array of independent disks (RAID), a floppy disk drive, a flash memory, a USB flash drive, an external hard disk drive, thumb drive, pen drive, key drive, a High-Density Digital Versatile Disc (HD-DVD) optical disc drive, an internal hard disk drive, a Blu-Ray optical disc drive, or a Holographic Digital Data Storage (HDDS) optical disc drive, an external mini-dual in-line memory module (DIMM) synchronous dynamic random access memory (SDRAM), or an external micro-DIMM SDRAM. Such computer readable storage media allow a computing device to access computer-executable process steps, application programs and the like, stored on removable and non-removable memory media, to off-load data from the device or to upload data onto the device. A computer program product, such as one utilizing a communication system may be tangibly embodied in storage medium 522, which may comprise a machine-readable storage medium. Machine-readable storage medium (which may also be referred to herein as “computer storage media”, “computer-readable storage medium” or “computer-readable storage media”) as used herein do not include transitory signals.

According to one example embodiment, the term computing device, as used herein, may be a CPU, or conceptualized as a CPU (for example, the CPU 502 of FIG. 5). In this example embodiment, the computing device may be coupled, connected, and/or in communication with one or more peripheral devices, such as display. In another example embodiment, the term computing device, as used herein, may refer to a mobile computing device, such as a smartphone or tablet computer. In this example embodiment, the computing device may output content to its local display and/or speaker(s). In another example embodiment, the computing device may output content to an external display device (e.g., over Wi-Fi) such as a TV or an external computing system.

In some embodiments of the disclosed technology, the computing device may include any number of hardware and/or software applications that are executed to facilitate any of the operations. In some embodiments, one or more I/O interfaces may facilitate communication between the computing device and one or more input/output devices. For example, a universal serial bus port, a serial port, a disk drive, a CD-ROM drive, and/or one or more user interface devices, such as a display, keyboard, keypad, mouse, control panel, touch screen display, microphone, etc., may facilitate user interaction with the computing device. The one or more I/O interfaces may be utilized to receive or collect data and/or user instructions from a wide variety of input devices. Received data may be processed by one or more computer processors as desired in various embodiments of the disclosed technology and/or stored in one or more memory devices.

One or more network interfaces may facilitate connection of the computing device inputs and outputs to one or more suitable networks and/or connections; for example, the connections that facilitate communication with any number of sensors associated with the system. The one or more network interfaces may further facilitate connection to one or more suitable networks; for example, a local area network, a wide area network, the Internet, a cellular network, a radio frequency network, a Bluetooth enabled network, a Wi-Fi enabled network, a satellite-based network any wired network, any wireless network, etc., for communication with external devices and/or systems. As desired, embodiments of the present invention can include the device computing system architecture with more or less of the components illustrated in FIG. 5.

The specific configurations, choice of materials and the size and shape of various elements can be varied according to particular design specifications or constraints requiring a system or method constructed according to the principles of the present disclosure. Such changes are intended to be embraced within the scope of the present disclosure. The presently disclosed embodiments, therefore, are considered in all respects to be illustrative and not restrictive. The patentable scope of certain embodiments of the present disclosure is indicated by the appended claims, rather than the foregoing description, and all changes that come within the meaning and range of equivalents thereof are intended to be embraced therein.

What is claimed is:

1. A computer-implemented method for managing application permissions, the method comprising:
receiving, at a computing device, a request to grant a set of requested permissions to an application installed on the computing device;
sending, from the computing device, a permission query request to a recommendation server, wherein the permission query request comprises an identifier for the application, and the set of requested permissions;
receiving, at the computing device, from the recommendation server, a set of permission recommendations, wherein the set of permission recommendations indicates whether the recommendation server recommends granting each requested permission from the set of requested permissions;
displaying the set of requested permissions and the set of permission recommendations;
determining a set of granted permissions for the application, granted by a user of the computing device, from the set of requested permissions; and
setting the permissions for the application on the computing device using the set of granted permissions.

2. The method of claim 1, wherein the computing device is a mobile device and the application is a mobile device application.

3. The method of claim 1, wherein the set of granted permissions are granted by the user based at least in part on the set of permission recommendations.

4. The method of claim 1, wherein the application is installed on the computing device in a probation mode or a trusted mode.

5. The method of claim 1, further comprising sending, from the computing device to the recommendation server, the set of granted permissions.

6. The method of claim 1, wherein the set of permission recommendations is based on granted permissions from other users of the application on other respective computing devices or another application on other respective computing devices that is configured to perform at least some of the same functions of the application.

7. The method of claim 6, wherein at least some of the other users are determined to be expert users and determining whether a user of the other users is an expert user comprises determining the correctness of granted permissions by the user of the other users, based on historical data.

8. The method of claim 1, wherein the set of permission recommendations comprises recommendations on whether granting one or more of the requested permissions poses a risk to at least one of security of the computing device and privacy of the user.

9. The method of claim 1, wherein at least one of receiving the request to grant a set of requested permissions to the application, sending the permission query request to the recommendation server, receiving the set of permission recommendations from the recommendation server, displaying the set of requested permissions and the set of permission recommendations, determining the set of granted permissions for the application, and setting the permissions for the application is performed during run-time of the application on the computing device.

10. A computing device, comprising:
at least one processor;
at least one memory operatively coupled to the at least one processor and configured for storing data and instructions that, when executed by the at least one processor, cause the computing device to perform a method comprising:
receiving a request to grant a set of requested permissions to an application installed on the computing device;
sending a permission query request to a recommendation server, wherein the permission query request comprises an identifier for the application, and the set of requested permissions;
receiving, from the recommendation server, a set of permission recommendations, wherein the set of permission recommendations indicates whether the recommendation server recommends granting each requested permission from the set of requested permissions;
displaying the set of requested permissions and the set of permission recommendations;
determining a set of granted permissions for the application, granted by a user of the computing device, from the set of requested permissions; and
setting the permissions for the application using the set of granted permissions.

11. The computing device of claim 10, wherein the computing device is a mobile device and the application is a mobile device application.

12. The computing device of claim 10, wherein the set of granted permissions are granted by the user based at least in part on the set of permission recommendations.

13. The computing device of claim 10, wherein the application is installed on the computing device in a probation mode or a trusted mode.

14. The computing device of claim 10, wherein the method performed by the computing device further comprising sending, to the recommendation server, the set of granted permissions.

15. The computing device of claim 10, wherein the set of permission recommendations is based on granted permissions from other users of the application on other respective computing devices or another application on other respective computing devices that is configured to perform at least some of the same functions of the application.

16. The computing device of claim 15, wherein at least some of the other users are determined to be expert users and determining whether a user of the other users is an expert user comprises determining the correctness of granted permissions by the user of the other users, based on historical data.

17. The computing device of claim 10, wherein the set of permission recommendations comprises recommendations on whether granting one or more of the requested permissions poses a risk to at least one of security of the computing device and privacy of the user.

18. The computing device of claim 10, wherein at least one of receiving the request to grant a set of requested permissions to the application, sending the permission query request to the recommendation server, receiving the set of permission recommendations from the recommendation server, displaying the set of requested permissions and the set of permission recommendations, determining the set of granted permissions for the application, and setting the permissions for the application is performed during run-time of the application on the computing device.

19. A non-transitory computer-readable storage medium having stored thereon instructions that, when executed by one or more processors, cause a computing device to perform a method comprising:
receiving a request to grant a set of requested permissions to an application installed on the computing device;
sending a permission query request to a recommendation server, wherein the permission query request comprises an identifier for the application, and the set of requested permissions;
receiving, from the recommendation server, a set of permission recommendations, wherein the set of permission recommendations indicates whether the recommendation server recommends granting each requested permission from the set of requested permissions;
displaying the set of requested permissions and the set of permission recommendations;
determining a set of granted permissions for the application, granted by a user of the computing device, from the set of requested permissions; and
setting the permissions for the application on the computing device using the set of granted permissions.

20. The non-transitory computer-readable storage medium of claim 19, wherein the method performed by the computing device further comprising sending, to the recommendation server, the set of granted permissions.
